(19) United States
(12) Patent Application Publication
(10) Pub. No.: US 2007/0151080 A1
(43) Pub. Date: Jul. 5, 2007

(54) Hinge

(76) Inventors: Sheng-Nan Lu, Shulin City (TW); Jia-Hao Hsu, Shulin City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/397,715

(22) Filed: Apr. 5, 2006

(30) Foreign Application Priority Data
Dec. 30, 2005 (TW) 094223107

(51) Int. Cl. E05D 11/08

(52) U.S. Cl. 16/340

(57) ABSTRACT

A hinge mounted between a cover and a base of a notebook has a base bracket having a lug and a mounting notch, a seat attached on the base bracket and having a lug and a tab mounted in the mounting notch, a cover bracket, a pintle having a proximal end mounted in the cover bracket and a distal end mounted through the lugs of the base bracket and the seat, a female limiting spacer attached to the lug of the base bracket, a male limiting spacer attached to the female limiting spacer, multiple resilient washers and frictional disks mounted around the distal end of the pintle, and a nut mounted around the distal end of the pintle to mount the pintle securely on the base bracket. The seat is easy to be attached on the base bracket by mounting the tab in the mounting notch for holding the pintle.

### BACKGROUND OF THE INVENTION

1. Field of the Invention

The present invention relates to a hinge, and more particularly to a hinge mounted in a notebook.

2. Description of the Related Art

A notebook has a cover and a base, and a screen is mounted on the cover. A hinge is mounted between the cover and the base and pivots to open or close the cover.

With reference to FIGS. 5-6, a conventional hinge in accordance with the prior art is mounted between a cover and a base of a notebook and comprises a base bracket assembly, a limiting spacer (75), multiple resilient washers (76), a first frictional disk (77), an inner spacer (78), a second frictional disk (85), an outer spacer (86), a cover bracket (60), a pintle (61) and a nut (87).

The base bracket assembly is mounted securely in the base of the notebook and has a base bracket (70), a seat (80) and a bolt (84).

The base bracket (70) is mounted securely in the base of the notebook, is L-shaped and has an inner edge, a bottom, a lug (73), a threaded hole (72) and an elongated hole (71). The lug (73) is formed on the inner edge of the base bracket (70), extends upward and has an outside surface and a mounting hole (74) defined though the lug (73). The threaded hole (72) is defined through the base bracket (70). The elongated hole (71) is defined through the base bracket (70) between the lug (73) and the threaded hole (72).

The seat (80) is attached to the bottom of the base bracket (70), is L-shaped and has an inner edge, a through hole (83) and a lug (81). The through hole (83) is defined through the seat (80) and corresponds to the threaded hole (72) of the base bracket (70). The lug (81) is formed on the inner edge of the seat (80), extends upward through the elongated hole (71) of the base bracket (70) and has an inside surface, an outside surface and a mounting hole (82). The mounting hole (82) of the lug (81) of the seat (80) is defined through the lug (81) and aligns with the mounting hole (74) of the lug (73) of the base bracket (70).

The bolt (84) is mounted through the through hole (83) of the seat (80) and screws into the threaded hole (72) of the base bracket (70) to secure the seat (80) to the base bracket (70).

The limiting spacer (75) engages the outside surface of the lug (73) of the base bracket (70) and has a through hole defined though the limiting spacer (75).

The resilient washers (76) are mounted in line between the lug (73) of the base bracket (70) and the lug (81) of the seat (80), are attached to the limiting spacer (75). Each resilient washer (76) has a through hole defined through the resilient washer (76), and the through holes of the resilient washers (76) align to each other.

The first frictional disk (77) is mounted between the resilient washers (76) and the lug (81) of the seat (80) and has a through hole. The through hole is defined through the first frictional disk (77) and is non-circular.

The inner spacer (78) is mounted between the first frictional disk (77) and the lug (81) of the seat (80), is attached to the inside surface of the lug (81) of the seat (80) and has a through hole. The through hole is defined through the inner spacer (78) and is non-circular.

The second frictional disk (85) is attached to the outside surface of the lug (81) of the seat (80) and has a through hole. The through hole is defined through the second frictional disk (85) and is non-circular.

The outer spacer (86) is attached to the second frictional disk (85) and has a through hole. The through hole is defined through the outer spacer (86) and is non-circular.

The cover bracket (60) is mounted securely in the cover of the notebook and has a stationary hole. The stationary hole is defined in the cover bracket (60) and is non-circular.

The pintle (61) has a proximal end, a distal end (62) and a head. The proximal end is mounted in the stationary hole of the cover bracket (60) and is non-circular in cross-section corresponding to the stationary hole. The distal end (62) is mounted sequentially through the mounting hole (74) of the lug (73) of the base bracket (70), the through hole of the limiting spacer (75), the through holes of the resilient washers (76), the through hole of the first frictional disk (77), the through hole of the inner spacer (78), the mounting hole (82) of the lug (81) of the seat (80), the through hole of the second frictional disk (85) and the through hole of the outer spacer (86), is non-circular in cross-section and has an outer thread (63) defined on the distal end (62). The head is formed between the proximal end and the distal end (62) of the pintle (61).

The nut (87) is mounted around the distal end (62) of the pintle (61) and screws onto the outer thread (63) of the distal end (62) to mount the pintle (61) securely on the base bracket (70).

However, to attach the seat (80) securely on the bottom of the base bracket (70) by screwing the bolt (84) into the threaded hole (72) of the base bracket (70) is inconvenient in assembly.

### SUMMARY OF THE INVENTION

The primary objective of the present invention is to provide a hinge to overcome the inconvenience of the conventional hinge in assembly.

The hinge in accordance with the present invention is mounted between a base and a cover of a notebook and has a base bracket assembly, a cover bracket, a pintle, a female limiting spacer, a male limiting spacer, multiple resilient washers, a first frictional disk, multiple second frictional disks and a nut.

The base bracket assembly is mounted securely in the base of the notebook and has a base bracket and a seat.

The base bracket is mounted securely in the base of the notebook and has an inner edge, an outer edge, a bottom, a mounting notch and a lug. The mounting notch is defined in the outer edge of the base bracket and has a width. The lug is formed on the inner edge of the base bracket, extends upward and has a mounting hole and a position hole.

The seat is mounted on the base bracket and has an inner edge, an outer edge, a lug and a tab. The lug is formed on the inner edge of the seat, extends upward and has a mounting hole. The tab is formed on the outer surface of the seat, extends downward, is mounted in the mounting notch of the base bracket and has a distal end. The distal end of the tab has a width that is larger than the width of the mounting notch to prevent the seat from detaching from the base bracket.

The cover bracket is mounted securely in the cover of the notebook and has a stationary hole.

The pintle is mounted on the base bracket and has a proximal end and a distal end. The proximal end is mounted in the stationary hole of the cover bracket. The distal end is mounted through the mounting hole of the lug of the base bracket and the mounting hole of the lug of the seat and has an outer thread defined around the distal end.

The female limiting spacer is mounted around the distal end of the pintle, abuts the lug of the base bracket and has an inside surface, an outside surface and a position bar. The position bar is formed on the inside surface of the female limiting spacer and extends into the position hole of the base bracket.

The male limiting spacer is mounted securely on the distal end of the pintle, selectively engages with the outside surface of the female limiting spacer. When the cover is opened, the male limiting spacer engages the female limiting spacer to hold the cover in an appropriate visual angle.

The resilient washers are mounted around the distal end of the pintle and deform to mitigate the gap between the male and the female limiting spacers when the male and female limiting spacers engage with each other.

The first frictional disk is mounted on the distal end of the pintle.

The second frictional disks are mounted on the distal end of the pintle.

The nut is mounted on the distal end of the pintle and screws onto the outer thread of the distal end to mount the pintle securely on the base bracket.

The seat is easy to be attached on the base bracket by mounting the tab of the seat in the mounting notch of the base bracket, and the width of the distal of the tab is larger than the width of the mounting notch to ensure that the seat does not detach from the base bracket, such that the pintle can be held in the mounting hole of the lug of the seat and the mounting hole of the lug of the base bracket.

### BRIEF DESCRIPTION OF THE DRAWINGS

FIG. 1 is a perspective view of a hinge in accordance with the present invention;

FIG. 2 is an exploded perspective view of the hinge in FIG. 1;

FIG. 3 is a side view of the hinge in FIG. 1;

FIG. 4 is a perspective view of the hinge in FIG. 1 mounted in a notebook;

FIG. 5 is a perspective view of a conventional hinge in accordance with the prior art; and

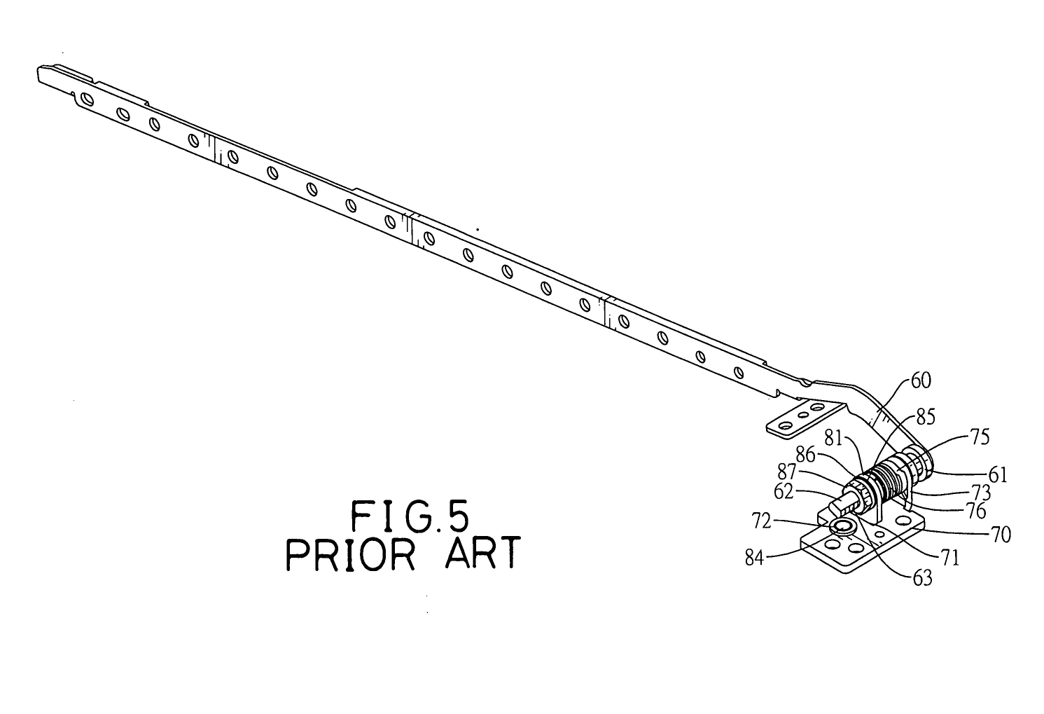

FIG. 6 is an exploded perspective view of the conventional hinge in FIG. 5.

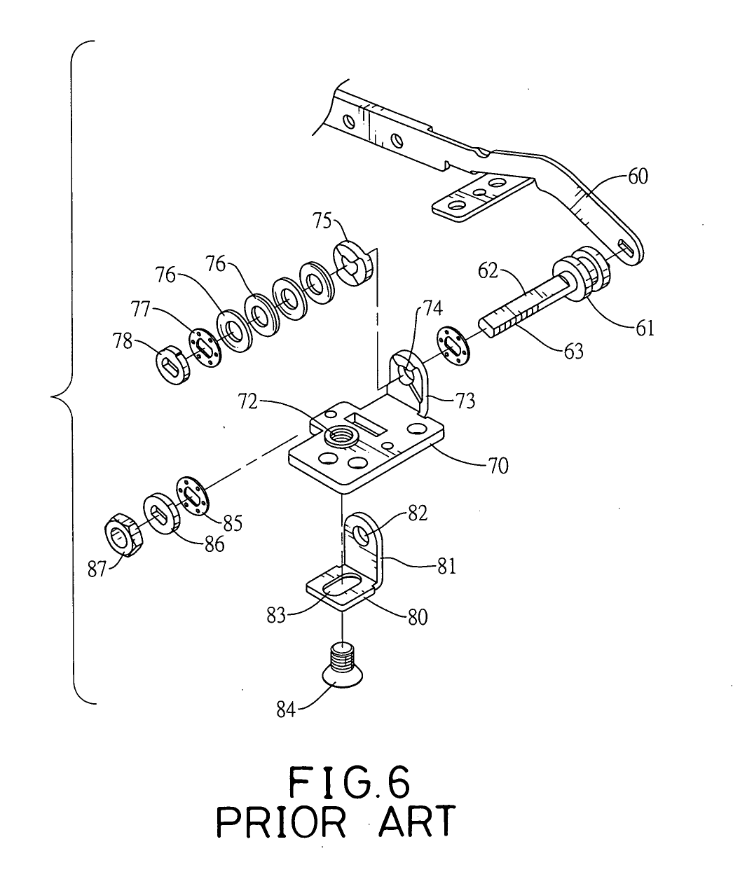

### DETAILED DESCRIPTION OF THE PREFERRED EMBODIMENT

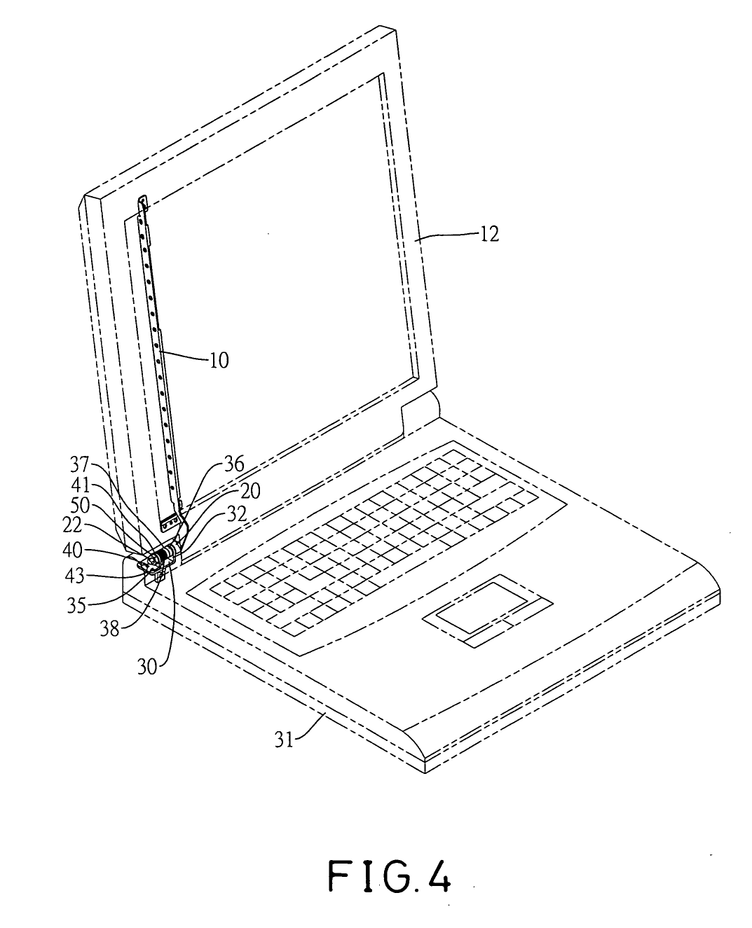

With reference to FIG. 4, a notebook has a cover (12), a base (31) and a hinge. The hinge is mounted between the cover (12) and the base (31) and pivots the cover (12) to open or close.

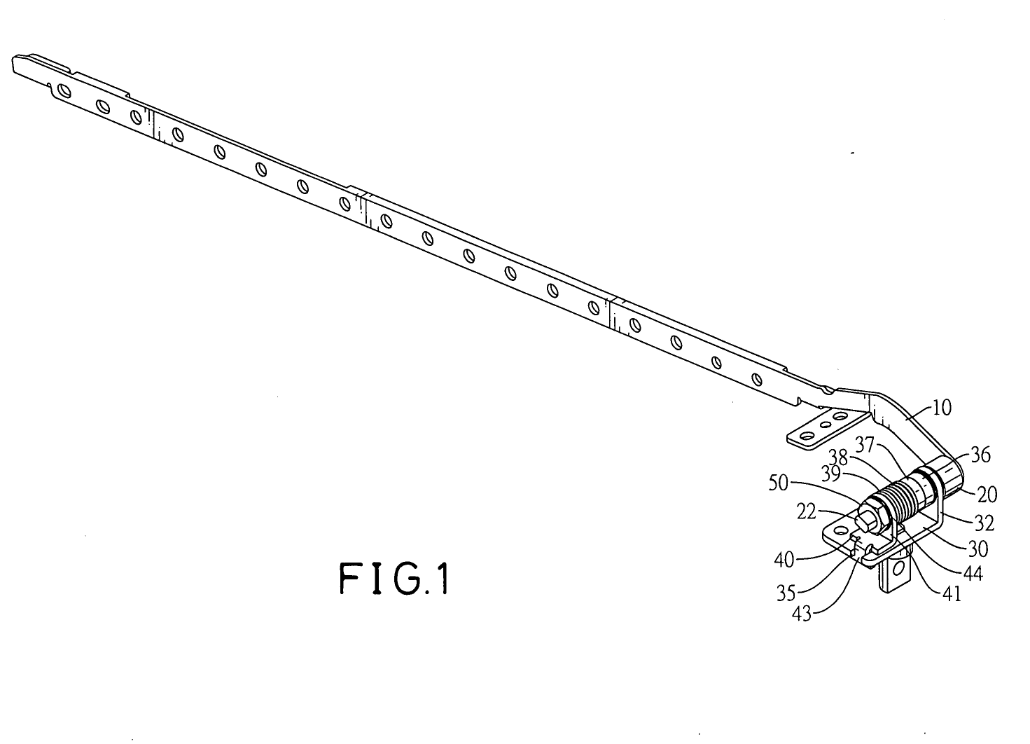

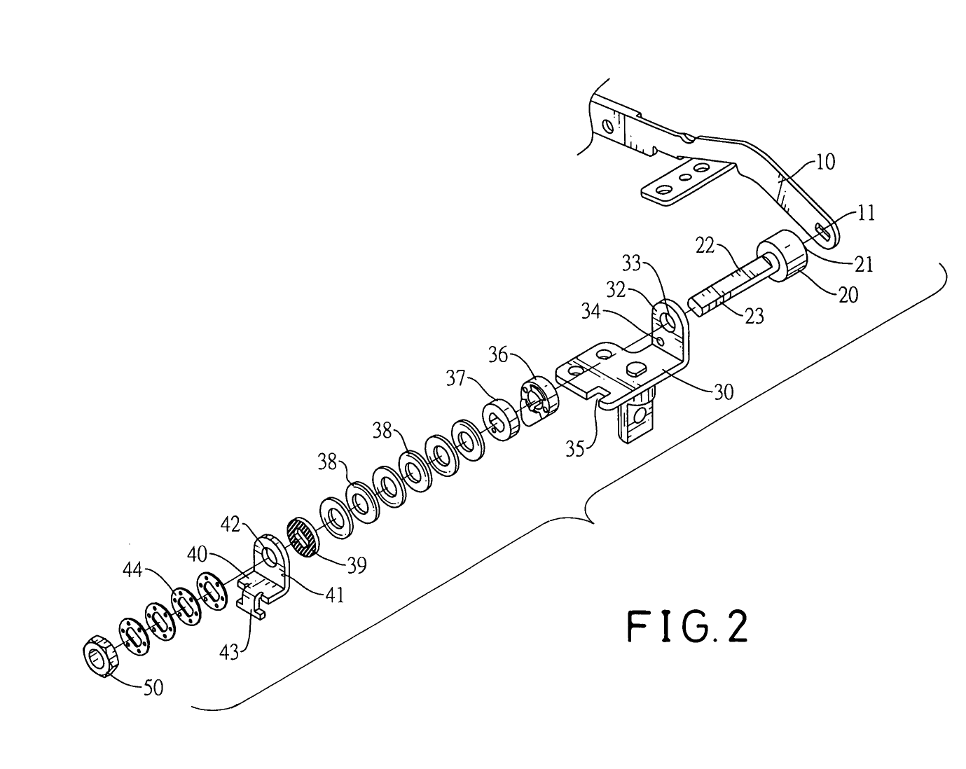

With reference to FIGS. 1-2 and 4, the hinge in accordance with the present invention comprises a base bracket assembly, a cover bracket (10), a pintle (20), a female limiting spacer (36), a male limiting spacer (37), multiple resilient washers (38), a first frictional disk (39), multiple second frictional disks (44) and a nut (50).

The base bracket assembly is mounted securely in the base (31) of the notebook and has a base bracket (30) and a seat (40).

The base bracket (30) is mounted securely in the base (31) of the notebook and has an inner edge, an outer edge, a bottom, a mounting notch (35) and a lug (32). The mounting notch (35) is defined in the outer edge of the base bracket (30) and has a width. The lug (32) is formed on the inner edge of the base bracket (70), extends upward and has an outside surface, a mounting hole (33) and a position hole (34). The mounting hole (33) is defined through the lug (32). The position hole (34) is defined through the lug (32) at a determined distance from the mounting hole (33).

The seat (40) is mounted on the base bracket (30) and has an inner edge, an outer edge, a lug (41) and a tab (43). The lug (41) is formed on the inner edge of the seat (40), extends upward and has a mounting hole (42) defined through the lug (41) of the seat (40). The tab (43) is formed on the outer surface of the seat (40), extends downward, is mounted in the mounting notch (35) of the base bracket (30) and has a distal end and two optional ears. The distal end of the tab (43) has a width that is larger than the width of the mounting notch (35) to prevent the seat (40) from detaching from the base bracket (30). The ears are formed on and protrude out from two opposite sides of the distal end of the tab (43) to form the tab in a T shape and abut the bottom of the base bracket (30) to prevent the seat (40) from detaching from the base bracket (30).

The cover bracket (10) is mounted securely in the cover (12) of the notebook, synchronously rotated with the cover (12) when the cover (12) is pivoted to open or close and has a stationary hole (11). The stationary hole (11) is defmed through the cover bracket (10) and is non-circular.

The pintle (20) is mounted in the cover bracket (10) and the base bracket (30) and has a proximal end (21), a distal end (22) and a head. The proximal end (21) is mounted in the stationary hole (11) of the cover bracket (10) to rotate the pintle (20) synchronously with the cover bracket (10) and is non-circular in cross-section corresponding to the stationary hole (11) of the cover bracket (10). The distal end (22) is mounted rotatably through the mounting hole (33) of the lug (32) of the base bracket (30) and the mounting hole (42) of the lug (41) of the seat (40), is non-circular in cross-section and has an outer thread (23) defined on the distal end (22). The head is formed near the proximal end of the pintle (20) and is mounted between the base bracket (30) and the cover bracket (10).

The female limiting spacer (36) is mounted around the distal end (22) of the pintle (20), abuts the outer surface of the lug (32) of the base bracket (30) and has an inside surface, an outside surface, a through hole, a position bar and two cutouts. The through hole is defined through the female limiting spacer (36) and is mounted around the distal end (22) of the pintle (20). The position bar is formed on the inside surface of the female limiting spacer (36) and extends into the position hole (34) of the base bracket (30). The cutouts are curved and are formed on the outside surface of the female limiting spacer (36) around the through hole of the female limiting spacer (36).

The male limiting spacer (37) is mounted securely on the distal end (22) of the pintle (20), abuts the outside surface of the female limiting spacer (36) and has an inside surface, a limiting hole and two protrusions. The limiting hole is defined through the male limiting spacer (37), corresponds to and is mounted securely on the distal end (22) of the pintle (20) to make the male limiting spacer (37) rotate synchronously with the pintle (20). The protrusions are formed on the inside surface of the male limiting spacer (37) around the limiting hole of the male limiting spacer (37) and selectively engage respectively with the cutouts of the female limiting spacer (36). When the cover (12) is opened, the distal end (22) of the pintle (20) rotates the male limiting spacer (37) and the protrusions engage the cutouts to hold the cover (12) in an appropriate visual angle.

The resilient washers (38) are mounted around the distal end (22) of the pintle (20) and each resilient washer (38) has a through hole mounted around the distal end (22) of the pintle (20). When the protrusions of the male limiting spacer (37) does not engage the cutouts of the female limiting spacer (36), the resilient washers deform to mitigate the gap between the male limiting spacer (37) and the female limiting spacer (36).

The first frictional disk (39) is mounted on the distal end (22) of the pintle (20) to generate friction with at least one of the resilient washers for holding the cover in any angle when the cover is pivoted to open and has a limiting hole. The limiting hole is defined through the first frictional disk (39), corresponds to and is mounted on the distal end (22) of the pintle (20) to make the first frictional disk (39) rotated synchronously with the pintle (20).

The second frictional disks (44) are mounted on the distal end (22) of the pintle (20) to generate friction with the lug (41) of the seat (40) for holding the cover in any angle when the cover is pivoted to open and each have a limiting hole. The limit hole is defined through the second frictional disk (44), corresponds to and is mounted on the distal end (22) of the pintle (20) to make the second frictional disk (39) rotated synchronously with the pintle (20).

The nut (50) is mounted on the distal end (22) of the pintle (61) and screws onto the outer thread (63) of the distal end (62) to mount the pintle (61) securely on the base bracket (30).

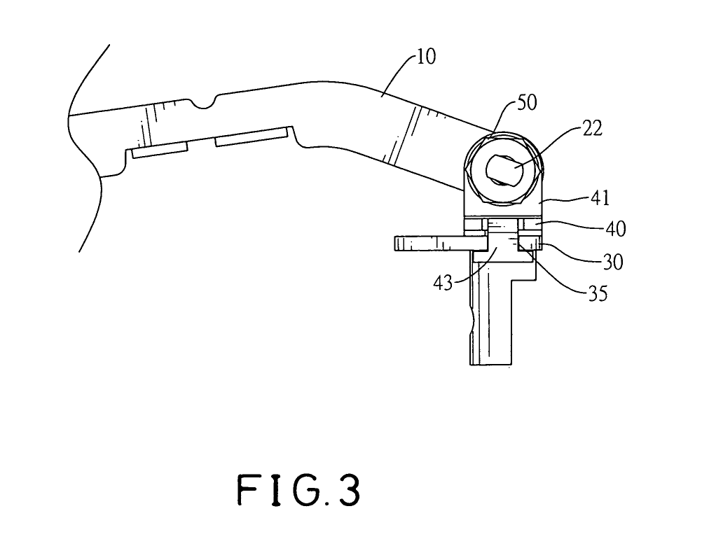

The pintle (20) is held stably in the mounting hole (42) of the lug (41) of the seat (40) and the mounting hole (33) of the lug (32) of the base basket (30). With further reference to FIGS. 1-3, to attach the seat (40) stably on the base bracket (30) by mounting the tab (43) of the seat (40) in the mounting notch (35) of the base bracket (30) is easy and convenient, and the width of the distal end of the tab (43) is larger than the width of the mounting notch (35) to ensure that the seat (40) does not detach from the base bracket (30).

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A hinge adapted for a notebook comprising:
a base bracket assembly having
a base bracket having
an inner edge;
an outer edge;
a bottom; and
a lug formed on the inner edge of the base bracket, extending upward and having
an outside surface;
a mounting hole defined through the lug; and
a position hole defined through the lug at a distance from the mounting hole; and
a seat mounted on the base bracket and having
an inner edge;
an outer edge; and
a lug formed on the inner edge of the seat, extending upward and having a mounting hole defined through the lug of the seat;
a cover bracket having
a stationary hole defined through the cover bracket and being non-circular;
a pintle mounted between the cover bracket and the base bracket and having
a proximal end mounted in the stationary hole of the cover bracket and being non-circular in cross-section corresponding to the stationary hole of the cover bracket;
a distal end mounted through the mounting hole of the lug of the base bracket and the mounting hole of the lug of the seat, being non-circular in cross-section and having
an outer thread defined on the distal end of the pintle; and
a head formed near the proximal end of the pintle and mounted between the base bracket and the cover bracket;
a female limiting spacer mounted around the distal end of the pintle, securely abutting the outer surface of the lug of the base bracket and having
an outside surface; and
a through hole defined through the female limiting spacer and mounted around the distal end of the pintle;
a male limiting spacer mounted securely on the distal end of the pintle, abutting the outside surface of the female limiting spacer and having
an inside surface selectively engaging with the outside surface of the female limiting spacer; and
a limiting hole defined through the male limiting spacer, corresponding to and mounted securely on the distal end of the pintle;
multiple resilient washers mounted around the distal end of the pintle and each resilient washer having a through hole mounted around the distal end of the pintle;
a first frictional disk mounted on the distal end of the pintle and having
a limiting hole defmed through the first frictional disk, corresponding to and mounted on the distal end of the pintle;
multiple second frictional disks mounted on the distal end of the pintle and each having
a limiting hole defined through the second frictional disk, corresponding to and mounted on the distal end of the pintle and inserted through by the distal end of the pintle; and
a nut mounted on the distal end of the pintle and screwing onto the outer thread of the distal end;
wherein the improvement comprises
the base bracket having
a mounting notch defined in the outer edge of the base bracket and having a width; and
the seat having
a tab formed on the outer surface of the seat, extending downward, mounted in the mounting notch of the base bracket and having a distal end.

2. The hinge as claimed in claim 1, wherein the distal end of the tab of the seat has a width that is larger than the width of the mounting notch of the base bracket.

3. The hinge as claimed in claim 2, wherein the tab of the seat further has two ears formed on and protruding out from two opposite sides of the distal end of the tab to form the tab in a T shape.
